(19) United States
(12) Patent Application Publication
(10) Pub. No.: US 2009/0298989 A1
(43) Pub. Date: Dec. 3, 2009

(54) 2K Waterborne Polyurethane Coating System and Methods Thereof

(76) Inventor: Randall A. Funston, SR., Wichita Falls, TX (US)

Correspondence Address: TARAS P. BEMKO, 301 GULF FREEWAY SOUTH, LEAGUE CITY, TX, 77573, US

(21) Appl. No.: 12/128,609

(22) Filed: May 28, 2008

(51) Int. Cl. C08K 3/08; C08L 75/04

(52) U.S. Cl. 524/440; 525/452; 525/123

(57) ABSTRACT

The present system is a waterborne coating system comprising a two-part aqueous polyurethane coating which provides for building solvent based equivalent film thickness without foaming or gassing while retaining properties of little or no volatile organic compound (VOC) or hazardous air pollutant (HAPs) emission. A blend of various acrylic copolomers neutralized in water based emulsion and combined with an emulsified polyester polyol provides the resin system allowing adhesion to a various number of substrates. In at least one embodiment, the acrylic polyol is an acrylic copolymer having the hydrophilizing groups and isocyanate-reactive functionality incorporated into the polymer via appropriate monomer selection or subsequent modification.

### TECHNICAL FIELD

The present disclosure relates to a waterborne coating system and method of application and, more particularly, to the use of a two-part aqueous polyurethane coating system which provides for building solvent based equivalent film thickness without foaming or gassing while retaining properties of little or no volatile organic compound (VOC) or hazardous air pollutant (HAPs) emission.

### BACKGROUND OF THE INVENTION

Currently, the coatings industry has been unsuccessful in developing a two part, water-borne polyurethane system that would build film thickness, like a solvent-borne industrial coating, where a minimum film build of two to three mils dry film thickness (DFT) is desired for commercial applications. Film thickness greater than two to three mils wet film thickness (WFT) in a water-borne polyurethane system has resulted in foaming and gassing. The foaming and gassing is primarily due to the reaction of isocyanate with moisture. Further current two part, water-borne polyurethane systems cannot achieve the desired product flow during application. The lack of proper flow frequently results with an eggshell type appearance which is unacceptable in higher scale commercial painting. Still further, newer environmental restrictions, that are being implemented across the United States, limit and/or eliminate the use of solvent-borne polyurethanes. Currently, the use of UV curing and polyasparitic technologies have been used to attempt an acceptable low VOC/HAP's free system.

Initially, aqueous polyurethane dispersions (PUDs), which maybe one and/or two-component coating systems, appeared in response to higher solvent prices and the increased demand for low-VOC coatings. These are usually made by reacting mixtures of polyols and dimethylolpropionic acid with a polyisocyanate to give a complete polyurethane or an isocyanate-terminated prepolymer. This product is then dispersed in water (which may contain other isocyanate-reactive compounds) by neutralizing the acid groups with a base, typically a tertiary amine. While aqueous PUDs provide a low-VOC alternative to traditional two-component, solvent-based coating formulations, they have some disadvantages. Because they are only lightly crosslinked, coatings from aqueous PUDs often lack adequate solvent resistance, water resistance, gloss, hardness, and weathering properties. In addition, a cosolvent is usually needed for good coalescence, so solvents are not easy to eliminate from the formulations and therefore the mandated environmental requirements of low VOC's and HAPs have been difficult to achieve.

In the early 1990s, two-component (2K) aqueous polyurethane coatings arrived on the scene (see generally: P. Jacobs et al., “Two-Component Waterborne Polyurethane Coatings: Now and Into the Next Century” and cited references). Scientists discovered that it is possible to use water as a carrier for reactive 2K systems and still get coatings with good appearance and physical properties. Two-component aqueous polyurethane coating formulations are typically dispersions of separate polyol and polyisocyanate moieties. A coating film forms after water evaporates and the components react to give a crosslinked polymer network. While 2K aqueous polyurethane coatings should, in theory, match the properties available from solvent-based 2K systems, the coatings have, in practice, lacked adequate water, solvent, and chemical resistance (particularly, but not limited to, resistance to Skydrol), gloss retention, weatherability, flexibility, and impact resistance.

The success of aqueous 2K systems has, until now, relied on some important and often unwieldy formulation twists. For example, the polyol required, which needs both hydroxyl functionality for the polyurethane-forming reaction and acid groups for water dispersibility, is usually not commercially available. In one approach, an acrylate polymer with acid and hydroxyl functionalities is made by copolymerizing (in a free-radical polymerization) an acrylic acid monomer and a hydroxyalkyl acrylate monomer (e.g., hydroxyethyl acrylate or hydroxyethyl methacrylate). Unfortunately, hydroxyalkyl acrylates are rather expensive. In addition, it is difficult to make hydroxyalkyl acrylate polymers that have both high hydroxyl functionality and molecular weights low enough to have value for low-VOC, crosslinkable coating systems. The result is a lower level of coating physical properties than would otherwise be desirable. Recently developed hydroxy-functional acrylate polymers based on allylic alcohols and alkoxylated allylic alcohols overcome some of the limitations of using hydroxyalkyl acrylate monomers. However, the value of these resins has, until now, been demonstrated primarily for solvent-based polyurethane coatings or with high-styrene (>50 wt. %) resins, and not for aqueous polyurethane coatings.

A second common way to tweak the 2K aqueous polyurethane coating formulation is to modify the polyisocyanate. Most of the work to date has used a polyisocyanate modified by partially reacting it with a hydrophilic polyether. Making the polyisocyanate hydrophilic provides an emulsifiable crosslinker having improved compatibility with the co-reactants. This approach also has disadvantages, however. First, the hydrophilic polyisocyanate must be synthesized. Second, more of the expensive hydrophilic polyisocyanate must be used (compared with the unmodified polyisocyanates) to get the same NCO functionality contribution. Third, the hydrophilicity of the polyisocyanate is incorporated into the coating, often making its water sensitivity unacceptably high.

A third approach modifies the processing while keeping a commercial polyisocyanate in the formulation. The key concern is how to adequately disperse the polyisocyanate in water because emulsions made from commercial polyisocyanates tend to agglomerate and settle. Adding cosolvents and emulsifiers can help, but this at least partially defeats the purpose of using an aqueous system.

At present, two-package solvent-based polyurethane coatings are widely used as coatings for substrates, such as metals, wood, and plastics. These two-package solvent-base urethanes can be cured at room temperature or cured at relatively lower temperature. Such urethanes yield coatings with high levels of mar resistance and chemical resistance. They are so good that they often give more protection than is needed by the substrate. Because these coating compositions are made with organic solvents, which must be liberated into the atmosphere, they cause environmental problems which makes desirable a switch to non-toxic, e.g., aqueous-based compositions. Moreover, because the solvent-containing compositions are often reduced (i.e., thinned) with strong non-polar to medium polar solvents, they often attack and degrade plastic substrates to an undesirable degree. Non-polar thermoplastics, such as aromatic polycarbonates, e.g., of bisphenol-A and phosgene, or polyphenylene ethers, e.g., poly(2,6-dimethyl-1,4-phenylene)ethers, are capable of being dissolved and/or attacked by such non-polar solvents, and they can be distorted with excessive heat.

### DETAILED DESCRIPTION OF EMBODIMENTS

Described herein is a two-component (2K) water based aqueous coating composition. It should be understood that various terms are used herein to describe the coating system such as, two-component (2K), two-part, and two-package. Further, the terms aqueous, waterborne, and water based are intended to be synonymous descriptive terms. As such, the specific term utilized should not be viewed as limiting.

Still further, the expression “isocyanate-reactive functionality” as utilized herein refers to the presence of functional groups that are reactive with isocyanate groups under conditions suitable for cured coating formation. Such isocyanate-reactive functionality is generally well known to those skilled in the coatings art and includes, most commonly, active hydrogen-containing functionality such as hydroxyl and amino groups.

By using a blend of various acrylic copolomers neutralized in water based emulsion and combining an emulsified polyester polyol to provide the resin system, adhesion to a various number of substrates was able to be achieved. Current technology necessary to provide direct to metal coating products that provide chemical resistance, gloss/color retention, and corrosion resistance have been achieved by the use of solvent based coating systems. Typically, such conventional coating products, to directly coat steel substrates, required blast abrasion of the surface prior to application, preferably to SP-5 or SP-10 requirements, to insure adhesion. Further, current aviation coating systems are of a chromate conversion coating which is a type of conversion coating applied to passivate aluminum, zinc, cadmium, copper, silver, magnesium, tin and their alloys to slow corrosion. The process uses various toxic chromium compounds which may include hexavalent chromium and thus may be released into the environment.

The system and method described herein can be applied to clean metal surfaces directly, without sand or waterblasting. Further, remarkable adhesion has been achieved on a variety of substrates including, but not limited to, aluminum, galvanized metal (both electroplated and hot-dipped), various stainless steels, PVC, carbon/fiberglass composites, and the like. This coating system can be applied at four to eight mils WFT, without foaming or gassing in the cured film as is typical with conventional water based systems. This accomplishment is accomplished synergistically using a combination of organic thickeners and pigments. Further, when combined with tin catalyst, MDI & HDI isocyanates the product meets the military specification requirements for conversion coat primer used by the aviation industry. The instant coating systems can be applied to a variety of solid substrates by conventional methods, such as flowing, spraying or dipping, to form a continuous surface film.

The acrylic polyol component of the present invention contains both functionality capable of reacting with isocyanate groups and hydrophilizing functionality capable of rendering the surface active isocyanate reactive material water dispersible. Hydroxyl functionality is typically utilized as the isocyanate-reactive functionality in coatings and is preferred for use in the present system.

In at least one embodiment, the acrylic polyol is an acrylic copolymer having the hydrophilizing groups and isocyanate-reactive functionality incorporated into the polymer via appropriate monomer selection or subsequent modification. Examples of monomers that may be utilized to synthesize the acrylic polyol include carboxyl group-containing ethylenically unsaturated monomers and hydroxyl group-containing ethylenically unsaturated monomers.

Although water can be used exclusively, other polar liquid solvents can replace part of the water, e.g., for volatility control. Alcohols are suitable for such purposes, including lower aliphatic alcohols such as methanol, ethanol, propanol, isopropanol, such as methanol, ethanol, propanol, isopropanol, n-butyl alcohol and t-butyl alcohol. Mixtures of such alcohols can also be utilized.

The coating system, described herein, meets the Military Specification (MIL spec—PRF-85582D) for VOC (50 grams/liter or less) and contains no HAPs. In order that those skilled in the art may better understand how to practice the present invention, the following examples are given by way of illustration and not by way of limitation.

In order to achieve the necessary film formation, this coating system must be manufactured under higher shear than can be obtained using high speed dispersion equipment. Preferably, the required shear is achieved through, but not limited to, a sand/bead/pebble/SW/horizontal milling process. The addition of any additives is preferably made in a specifically chosen order to obtain desired sag resistance. When desired, thinning is preferably done to the base prior to mixing the component A and component B. However, the thinning may also be applied at other steps such as, but not limited to, thinning after mixing components A and B. The thinning is preferably limited to a range of 0 to 25% water. It is contemplated herein that those skilled in the art, will recognize, with time and further study, that other methods of thinning may be discovered which still maintain the desired characteristics of the coatings disclosed herein as well as the desired low VOC's and HAP's. Thus, the exact and/or preferred methodology of thinning, disclosed herein, should not be viewed as a limitation herein. It should be further understood that the improper use or the unnecessary elimination of this step (thinning) will likely result in an unwanted viscosity and undesired air entrapment in the coating.

Preferably, the desired 2K coating system is comprised of a part A and a part B. Part A is preferably a carboxyl group-containing urethane prepolymer, said prepolymer dispersed in a polar liquid medium comprising predominantly water. Part B is preferably a hexane, 1,6-diisocyanato-homopolymer poly(oxy-1,2-ethanediyl), alpha-tridecyl-o mega,-hydroxy-phosphate. In at least one embodiment, part A includes solids in a range of 30-70% by weight. In one embodiment, these solids may be a water dispersible thermoplastic carboxylated acrylic polymer. In another embodiment, a zinc having a unique particle structure is added in a range of up to 20% by weight.

Various embodiments of the coating system maybe utilized to form a DTM topcoat, a water based zinc primer, and/or a waterbased zinc conversion coating primer. Each of these coating systems preferably employs the two-component (parts A and B) formulation.

### EXAMPLE 1

DTM Topcoat Formulation. The preferred mixture of parts A and B is a 2:1 mix ratio by volume.

### Part A Formulation:

Acrylic Copolymer (preferred range—20-70% )
Acrylic Urethane Polyol (preferred range—20-70%)
Modified poloydimethyl siloxane (preferred range—0.25-2.0%)
Ti02 (preferred range—10-30%)
Polyurethane based thickening agent (preferred range—0.2-0.5%)
Diphenyl poloyglycol ether (preferred range—0.2-0.5% )
Polymeric non-ionic dispersant (preferred range—0.2-0.5%)
Hindered amine light stabilizer (preferred range—0.2-1.0%)
Hydroxyphenyl-benzotriazole UV Absorber (preferred range—0.2-1.0%)
Non-ionic Surfactant (preferred range—0.2-1.0%)
Water (preferred range—5-25%)

### Part B Formulation:

Aliphatic polyisocyanate (preferred range—80-100%)
Diethylene Glycol Monobutyl Ether (preferred range—0-20%) (optional)
   Note: It should be understood that increased viscosity and/or poor film coalescence may result without the addition of the diethylene glycol monobutyl ether.

### EXAMPLE 2

Water based zinc primer formulation. The preferred mixture of parts A and B is a 3:1 mix ratio by volume.

### Part A Formulation:

Acrylic Copolymer (preferred range—20-70%)
Acrylic Urethane Polyol (preferred range—20-70%)
Modified poloydimethyl siloxane (preferred range—0.25-2.0%)
TiO2 (preferred range—5-10%)
Zinc pigment (preferred range—10-20%)
Magnesium silicate (preferred range—5-15%)
Calcium Carbonate (preferred range—5-15% )
Calcined kaolin clay (preferred range—5-15%)
Carbon Black (preferred range—0.2-2.0% )
Polyurethane based thickening agent (preferred range—0.2-0.5%)
Diphenyl poloyglycol ether (preferred range—0.2-0.5%)
Polymeric non-ionic dispersant (preferred range—0.2-0.5%)
Hindered amine light stabilizer (preferred range—0.2-1.0%)
Hydroxyphenyl-benzotriazole UV Absorber (preferred range—0.2-1.0%)
Non-ionic Surfactant (preferred range—0.2-1.0%)

### Part B Formulation:

Aliphatic polyisocyanate (preferred range—80-100%)
Diethylene Glycol Monobutyl Ether (preferred range—0-20%) (optional)
   Note: It should be understood that increased viscosity and/or poor film coalescence may result without the addition of the diethylene glycol monobutyl ether.

### EXAMPLE 3

Water Based zinc conversion coating primer formulation. The preferred mixture of parts A and B is a 3:1 mix ratio by volume.

### Part A Formulation:

Acrylic Copolymer (preferred range—20-70%)
Acrylic Urethane Polyol (preferred range—20-70%)
Modified poloydimethyl siloxane (preferred range—0.25-2.0%)
TiO2 (preferred range—5-10%)
Zinc pigment (preferred range—10-20%)
Magnesium silicate (preferred range—5-15%)
Calcium Carbonate (preferred range—5-15%)
Calcined kaolin clay (preferred range—5-15%)
Carbon Black (preferred range—0.2-2.0%)
Polyurethane based thickening agent (preferred range—0.2-0.5%)
Diphenyl poloyglycol ether (preferred range—0.2-0.5%)
Polymeric non-ionic dispersant (preferred range—0.2-0.5%)
Hindered amine light stabilizer (preferred range—0.2-1.0%)
Hydroxyphenyl-benzotriazole UV Absorber (preferred range—0.2-1.0%)
Non-ionic Surfactant (preferred range—0.2-1.0%)

### Part B Formulation:

Polomeric MDI (preferred range—2-100%)
Aliphatic polyisocyanate (preferred range—0-8%)
Diethylene Glycol Monobutyl Ether (preferred range—0-20%) (optional)
   Note: It should be understood that increased viscosity and/or poor film coalescence may result without the addition of the diethylene glycol monobutyl ether.

In at least one embodiment, the following performance characteristics were successfully tested:

TOP COAT PERFORMANCE PROPERTIES
Product: Aqua Thane series Acrylic Polyurethane

| Test | Spec Requirements | Test Method |
|---|---|---|
| VOC | <50 grams/liter | EPA Method 24 |
| DFT | 2.0-2.5 mils | ASTM D4138-07 |
| Mix Ratio | 2:1 by volume | As formulated |
| Storage Stability | 6 months in plastic container | Manufacture Certification |
| Pot Life | 4 hours | #4 Ford - 8 seconds increase |
| | | at 4 hours |
| Thinning | 0-25% with water | Manufacture Requirement |
| Dry Time | Dry hard: overnight | ASTM D1640 |
| | Full Cure: 7 days | |
| Gloss | >/=90% | ASTM D523-89 |
| Gloss Retention | >/=80% | After 500 hours Xenon Arc |
| | | testing ASTM D523 |
| Humidity Cabinet | 30 days | ASTM D1748 |
| Flexibility | Not less than 10% | GE impact |
| Adhesion | >/=4A | ASTM D3359 |
| Water Resistance | Immersion in water @ | Visual |
| | 120° F. for 4 days | |
| Salt Spray | 2,000 hour minimum | ASTM B117 |
| Solvent Resistance | 50 MEK rubs | Visual |
| Fluid Resistance | 24 hour immersion in hydraulic | Visual |
| | fluid & lubricating oil | |

The coating system described herein is preferably manufactured as follows. Part A is preferably made using high shear by a bead mill to disperse the pigments. Next, a high speed disperser is used to incorporate the resins and additives in the product described herein. It has been discovered, that one of the important features of an additive is the consistency of the zinc. Typically, zinc is added in the form of zinc dust. However, in at least one embodiment, the coating described herein, utilizes a zinc flake instead of dust. The zinc flake provides, in at least one aspect, the advantage of a larger surface area than a zinc dust particle. Thus, the cathodic protection, of the target surface, is preferably both increased and is achieved through the use of less zinc product. Those, skilled in the art, will appreciate this aspect as the “overlap” effect of the flakes (versus dust particles) will provide an improved barrier resistance. Part B is preferably made by blending the isocyanate with diethylene glycol monobutyl ether for the topcoat and diethylene glycol monobutyl ether plus polomeric MDI in the zinc primer. Preferably, the two components are stored at temperatures in a preferred range of between 50-100° F.

In order to achieve the necessary film formation, this product must be manufactured under higher shear than can be obtained using conventional high speed dispersion equipment. The higher shear is preferably obtained through two separate steps. First a bead mill (such as, but not limited to, a Red Hear Horizontal mill) is utilized to disperse the organic and inorganic pigments. The second step preferably blends the resin and predispersed pigment slurry until a homogenous mixture is achieved. Such high speed dispersion equipment maybe but is not limited to Myers Cowels High Speed Dispersion Equipment. It should be understood that other methods of achieving the higher shear is contemplated herein and should not be viewed as a limitation herein. It should be further understood that the addition of the additives is preferably in a particular order to obtain the desired sag resistance, however, the exact order of additive addition should not be viewed as a limitation herein.

The preferred method of application requires that the target surface be free of substantially all oil, grease, dirt or other contaminants. Preferably, the surface may be washed with a solvent or other surface cleaner in accordance with SSPC-SP1. However, it should be appreciated that due to environmental issues cleaners other than solvents should be utilized on the target surface. These alternatives to solvent will provide the desired preparation as well as substantially prevent or reduce potential HAPs and/or VOC emissions. It should be understood, by those skilled in the art, that such products are identified in the industry as green adhesion promoters. It should be understood that other cleaning methodology may be employed and the method of cleaning should not be view as a limitation herein. Further, it should be understood that the material of the substrate, to be coated, may direct the preferred materials used for the cleaning.

The surface should also be substantially free of any rust, paint, or other debris which may prevent the coating from being applied to the target substrate. Such preparation may be carried out in accordance with SSPC-SP2. If the surface has been previously painted or coated, it is preferable that any glossy surfaces be sanded or primed. A preferred primer is Aqua-Bond ACWP-W-300 manufactured by Excalibur Paint & Coatings, Ltd (Aqua-Bond is a common law trademark of Excalibur Paint & Coatings, Ltd). If the substrate requires a wash/conversion coating (either by specification or owner requirement), the substrate may preferably be coated with ACWP-W-300 and followed with an intermediate coating of ACWX-W-300 (manufactured by Excalibur Paint & Coatings) and/or ACWP-W-300. It should be understood that in one embodiment, the herein described coating system may, when necessary or desired, be applied directly to a surface substrate with substantially no surface preparation.

For optimum results, the herein described coating system is preferably applied when temperatures are in a range of 60 to 80 degrees Fahrenheit with a relative humidity below 70%. However, those skilled in the art can appreciate that such optimum conditions may be difficult to encounter. As such, application under various circumstances, requiring longer or shorter drying times, and/or artificial temperature controls are contemplated herein and should not be viewed as a limitation of the herein described system and method. As mentioned herein above, the coating system may be applied utilizing a variety of spray systems, brushes, rollers, and the like.

Prior to application, the two components (Part A and Part B) must be mixed and/or thinned. Preferably, each part should be thoroughly mixed in its own container much akin to mixing a conventional container of paint (i.e. so that no pigment remains at the bottom of the container and that the color is uniform). Part A and Part B should be mixed together according to the proper mix ratio by volume for approximately two to three minutes. It should be understood that this mixing time is a preferred range but factors such as mixing equipment, weather, temperature, environment, and the like may influence the required mixture time and should not be viewed as a limitation herein. Preferably, components A and B, when mixed have a pot life of approximately 4 hours at temperatures of about 70 degrees Fahrenheit and a relative humidity of 50%. It should be understood, by those skilled in the art, that the pot life will vary at different conditions and that only a sufficient quantity of parts A and B should be mixed so as to not exceed the pot life thus wasting the coating material. It is further preferable to allow a period of approximately one half hour after mixing parts A and B and prior to the application of the coating system on a target surface. When necessary or desired, the mixture can be thinned. Preferably, the thinning is done to the base prior to mixing parts A and B by adding up to 25% water, by weight. As disclosed hereinabove, it is contemplated that other thinning methodology may be incorporated and as such should not be viewed as a limitation herein. It should be understood that improper or undesired viscosity and air entrapment could result if thinning is not performed when necessary. Preferably, but not limited to, the thinning is done after Part A and Part B have been mixed. It should be further understood that there should be approximately a four hour wait time between topcoating the zinc primer with the urethane topcoat (at the preferred temperature of approximately 75° F.). The topcoat should be given at least a twenty four (24) hour cure time prior to striping, stenciling, or recoating. It should be apparent that this cure time depends on environmental conditions and may vary.

Obviously, other modifications and variations of the present invention are possible in the light of the above teachings. It is therefore to be understood that changes may be made in the particular embodiments described above which are within the full intended scope of the invention as defined in the appended claims.

While the present system and method has been disclosed according to the preferred embodiment, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the system or methods disclosed hereinto those particular embodiment configurations. These terms may reference the same or different embodiments, and are combinable into aggregate embodiments. The terms “a”, “an” and “the” may also mean “one or more”.

None of the description in this specification should be read as implying that any particular element, step or function is an essential element which must be included in the claim scope. The scope of the patented subject matter is defined by the allowed claims and their equivalents. Unless explicitly recited, other aspects of the instant disclosure as described in this specification do not limit the scope of the claims. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

I claim:

1. A two-part aqueous coating system comprising:
a first part, said first part being a prepolymer;
said prepolymer being dispersed in a polar liquid medium; and
a second part, said second part being a hexane, 1,6-diisocyanato-homopolymer poly(oxy-1,2-ethanediyl), alpha-tridecyl-o mega,-hydroxy-phosphate; wherein said first part and said second part are mixed together prior to an application of said coating system.

2. The coating system of claim 1, said prepolymer further comprises a carboxyl group-containing urethane.

3. The coating system of claim 1, said polar liquid medium comprising predominantly water.

4. The coating system of claim 1, said first part further comprising a range of 30-70% by weight of solids basis.

5. The coating system of claim 4, wherein said solids basis is a water dispersible thermoplastic carboxylated acrylic polymer.

6. The coating system of claim 1, said first part further comprising an acrylic copolymer in a range of 20-70% by weight.

7. The coating system of claim 1, said first part further comprising an acrylic urethane polyol in a range of 20-70% by weight.

8. The coating system of claim 1, said first part further comprising a zinc pigment in a range of 10-20% by weight.

9. The coating system of claim 8, wherein zinc is substantially in the form of a flake.

10. The coating system of claim 9, wherein said zinc flake has a micron size ranging from 13-20.

11. The coating system of claim 1, said second part further comprising an aliphatic polyisocyanate in a range of 80-100% byweight.

12. The coating system of claim 1, said second part further comprising an aliphatic polyisocyanate in a range of up to 8% by weight.

13. The coating system of claim 1, said second part further comprising an diethylene glycol monobutyl ether in a range of up to 20% by weight.

14. The coating system of claim 1, wherein said first part and said second part are mixed in substantially a 2:1 ratio.

15. The coating system of claim 1, wherein said first part and said second part are mixed in substantially a 3:1 ratio.

16. A method for applying a two-part aqueous coating system comprising the steps of:
providing a first part, said first part being a prepolymer;
providing a second part, said second part being a hexane, 1,6-diisocyanato-homopolymer poly(oxy-1,2-ethanediyl), alpha-tridecyl-o mega, -hydroxy-phosphate;
thinning said first part;
mixing said first part and said second part; and
applying said first part and said second part to a desired surface.

17. The method of claim 16, wherein said thinning is done with water and/or water based fluid.

18. The method of claim 17, wherein said water is added in a range of up to 25% by weight.

19. The method of claim 16, wherein said thinning fluid is a non water based fluid.

20. The method of claim 16, wherein said prepolymer further comprises a carboxyl group-containing urethane.

21. The method of claim 16, said first part further comprising a zinc pigment in a range of 10-20% by weight.

22. The method of claim 21, wherein zinc is substantially in the form of a flake.

23. The coating system of claim 22, wherein said zinc flake has a micron size ranging from 13-20.

24. The method of claim 16, wherein said mixing further comprising the steps of:
adding a desired ratio of said first part and said second part; and
mixing said parts for approximately two-three minutes.

25. A method of manufacturing a two-part aqueous coating system comprising the steps of:
mixing a first part in a bead mill, wherein said mixing disperses organic and inorganic pigments of said first part;
blending a resin and said dispersed pigments of said first part in a high speed dispersion machine, wherein said blending achieves a substantially homogenous mixture;
mixing a second part in a bead mill, wherein said mixing disperses organic and inorganic pigments of said second part;
blending a resin and said dispersed pigments of said second part in a high speed dispersion machine, wherein said blending achieves a substantially homogenous mixture; and
adding desired additives, wherein said additives increase sag resistance.

26. The method of claim 25, wherein said first part and said second part are mixed together prior to application onto a desired surface.
